(19) United States
(12) Patent Application Publication
(10) Pub. No.: US 2026/0285389 A1
(43) Pub. Date: Sep. 24, 2026

(54) IN-VEHICLE SYSTEM AND STORAGE MEDIUM

(71) Applicant: SONY HONDA MOBILITY INC., Tokyo (JP)

(72) Inventor: Ryu TATE, Tokyo (JP)

(73) Assignee: SONY HONDA MOBILITY INC., Tokyo (JP)

(21) Appl. No.: 19/088,584

(22) Filed: Mar. 24, 2025

(51) Int. Cl. B62D 1/04

(52) U.S. Cl. CPC B62D 1/046

(57) ABSTRACT

A user experience of improved vibration effects is provided. A vibration pattern determination unit determines vibration pattern data to be used to generate vibration with a vibration effect selected by a user from among a plurality of vibration effects to be generated in a steering wheel of a vehicle, and a signal generation unit generates a signal for generating vibration according to the vibration pattern data supplied from the vibration pattern determination unit. The present technology is applicable to, for example, an in-vehicle system of a vehicle with vibration devices mounted on its steering wheel.

### BACKGROUND OF THE INVENTION

### Field of the Invention

The present disclosure relates to an in-vehicle system and a storage medium, and particularly relates to an in-vehicle system and a storage medium with which it is possible to provide a user experience of improved vibration effects.

### Description of the Related Art

Technologies for conveying information to a driver operating the steering wheel of a vehicle to drive the vehicle by vibrating a vibration device mounted on the steering wheel have been conventionally known.

For example, U.S. Pat. No. 9,623,907 discloses a technology for conveying navigation information to an occupant of a vehicle by driving a plurality of actuators included in a steering mechanism of the vehicle. U.S. Pat. No. 10,286,922 discloses a technology for conveying information indicating a left turn or a right turn to an occupant of a vehicle by vibrating a left-side vibrator or a right-side vibrator disposed on the steering wheel of the vehicle.

Conventionally, mechanisms to provide a visual or haptic user experience of steering wheel vibration in a vehicle have not been sufficiently prepared, and it has been difficult to showcase performance of the vibration to a customer (user) at a vehicle exhibition, for example.

The present disclosure is made in view of such a situation and makes it possible to provide a user experience of improved vibration effects.

### SUMMARY OF THE INVENTION

An in-vehicle system according to an aspect of the present disclosure includes a vibration pattern determination unit configured to determine vibration pattern data to be used to generate vibration with a vibration effect selected by a user from among a plurality of vibration effects to be generated in a steering wheel of a vehicle, and a signal generation unit configured to generate a signal for generating vibration according to the vibration pattern data supplied from the vibration pattern determination unit.

A storage medium according to an aspect of the present disclosure stores a program for causing a computer to execute processing including determining vibration pattern data to be used to generate vibration with a vibration effect selected by a user from among a plurality of vibration effects to be generated in a steering wheel of a vehicle, and generating a signal for generating vibration according to the vibration pattern data.

In an aspect of the present disclosure, vibration pattern data to be used to generate vibration with a vibration effect selected by a user from among a plurality of vibration effects to be generated in a steering wheel of a vehicle is determined, and a signal for generating vibration according to the vibration pattern data is generated.

According to an aspect of the present disclosure, it is possible to provide a user experience of improved vibration effects.

Note that effects described herein are not necessarily limiting, and any effect described in the present disclosure may be applicable.

### BRIEF DESCRIPTION OF THE DRAWINGS

FIG. 1 is a diagram schematically illustrating the interior of a cabin of a vehicle in which a steering wheel SW with vibration devices VD1 and VD2 mounted thereon is installed;

FIG. 2 is a diagram illustrating an exemplary configuration of a system including a control device 100;

FIG. 3 is a block diagram illustrating an exemplary functional configuration of a vibration effect system 200;

FIG. 4 is a diagram for description of an example of a GUI screen; and

FIG. 5 is a flowchart for description of vibration effect processing.

### DETAILED DESCRIPTION OF THE INVENTION

The following describes embodiments for implementing the present technology. The description is made in the following order.
1. Exemplary overall configuration of vehicle
2. Exemplary configuration of vibration effect system
3. Exemplary processing of vibration effect processing

### Exemplary Overall Configuration of Vehicle

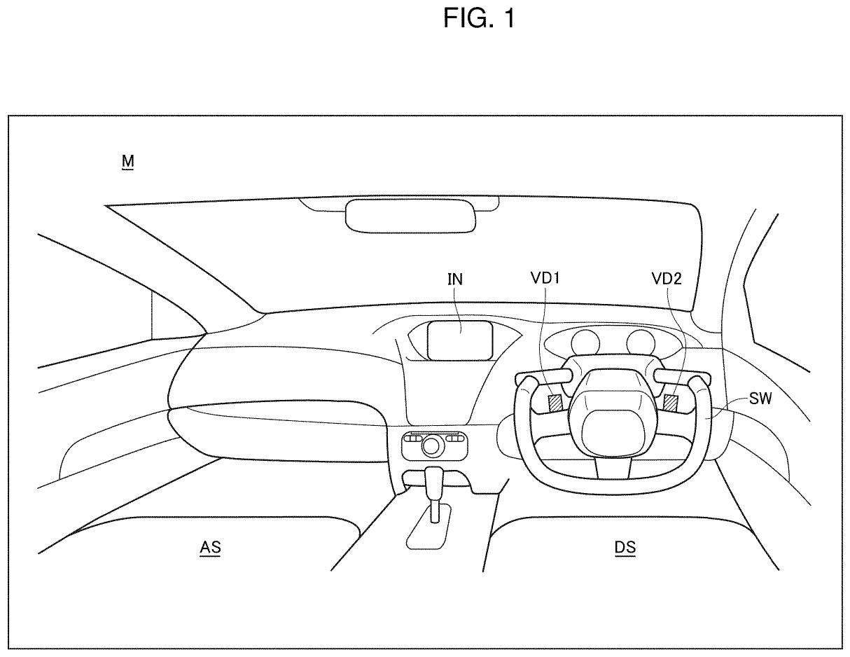

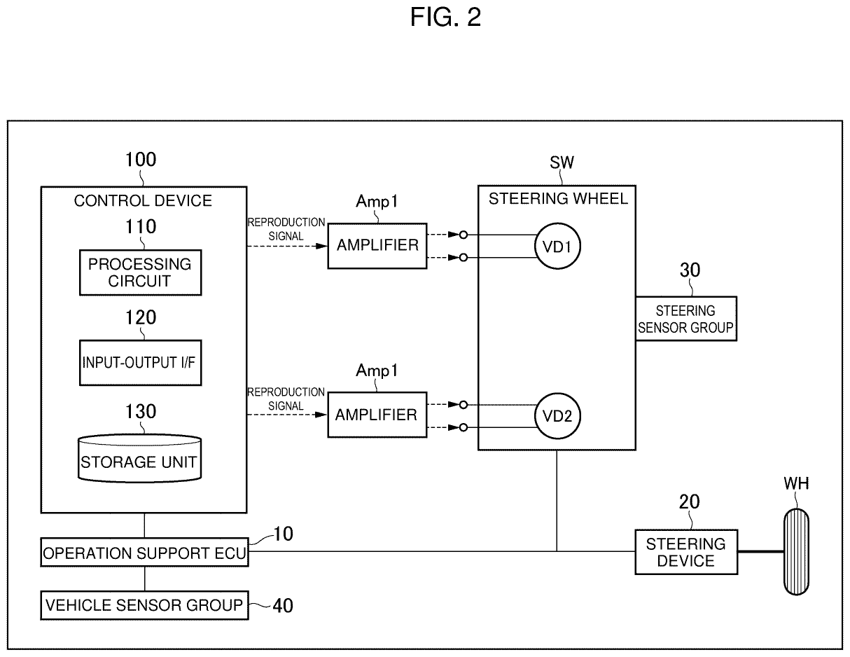

An exemplary overall configuration of a vehicle with a mounted vibration effect system to which the present technology is applied will be described below with reference to FIGS. 1 and 2.

FIG. 1 is a diagram schematically illustrating the interior of a cabin of a vehicle M in which a steering wheel SW with vibration devices VD1 and VD2 mounted thereon is installed. FIG. 2 is a diagram illustrating an exemplary configuration of a system including a control device 100 configured to control the vibration devices VD1 and VD2.

The vehicle M includes an instrument panel IN, a driver seat DS, a front passenger seat AS, the steering wheel SW, and the like in the cabin. The vehicle M is, for example, a two-wheeled, three-wheeled, four-wheeled vehicle, and its drive source is an internal combustion engine such as a diesel engine or a gasoline engine, an electric motor, or a combination thereof. FIG. 1 illustrates a case where the vehicle M is a four-wheeled vehicle as an example.

A steering sensor group 30 configured to detect an operation amount (angle) or the presence or absence of an operation is attached to the steering wheel SW, and a detection result is output to an operation support electronic control unit (ECU) 10 and a steering device 20. The steering wheel SW is not necessarily required to be circular and may be a non-circular steering wheel.

In addition, the vibration devices VD1 and VD2 are mounted on the left and right sides of the steering wheel SW. The vibration devices VD1 and VD2 each incorporate a motor, and when receiving a reproduction signal provided by the control device 100 and amplified by amplifiers Amp1 and Amp2, they operate the motors according to the received reproduction signal to generate vibration on the steering wheel SW. The amplifiers Amp1 and Amp2 are connected to the vibration devices VD1 and VD2, respectively, through cable reels.

For example, voice coil motor (VCM) vibrators capable of achieving highly expressive vibration may be used as the vibration devices VD1 and VD2. The VCM vibrators can use, for example, a reproduction signal that reproduces audio when supplied to a speaker as an input, and can achieve haptic directional representation by generating vibrations that realize tonal differentiation such as timbre. Eccentric motors with an unbalanced center of gravity may be used as the vibration devices VD1 and VD2.

As illustrated in FIG. 1, in the present embodiment, the vibration device VD1 is installed on the left side of the steering wheel SW to convey vibration to the left hand of a driver gripping the steering wheel SW, while the vibration device VD2 is installed on the right side of the steering wheel SW to convey vibration to the right hand of the driver gripping the steering wheel SW.

The steering device 20 includes, for example, a steering ECU and an electric motor. For example, the electric motor applies force to a rack-and-pinion mechanism to change a direction of steered wheels WH. The steering ECU drives the electric motor according to information input from the operation support ECU 10 or information input from the steering wheel SW, thereby changing the direction of the steered wheels WH.

The steering sensor group 30 includes, for example, a steering grip sensor and a vibration displacement sensor. The steering grip sensor is implemented by a capacitive sensor or the like and outputs, to the operation support ECU 10, a signal that enables sensing of whether the driver is gripping the steering wheel SW (that is, in contact with it in a state in which force can be applied). The vibration displacement sensor measures displacement [cm] of vibration generated at each position (point) on the steering wheel SW as vibration intensity and outputs the measured vibration intensity to the control device 100. In this case, the measured vibration intensity may be directly output to the control device 100 not through the operation support ECU 10.

A vehicle sensor group 40 includes an image sensor installed to capture an image of a surrounding situation of the vehicle M by using a solid image capturing element such as a charge coupled device (CCD) or a complementary metal oxide semiconductor (CMOS), a vehicle speed sensor that detects a speed of the vehicle M, an acceleration sensor that detects its acceleration, a yaw rate sensor that detects its angular velocity about a vertical axis, an orientation sensor that detects an orientation of the vehicle M, and the like.

The operation support ECU 10 executes an advanced driver assistance system (ADAS) based on detection results by the vehicle sensor group 40. The ADAS includes, for example, a lane departure warning (LDW) that warns of departure of the vehicle M from a driving lane. As an example, the operation support ECU 10 can execute the ADAS by generating vibration from the vibration devices VD1 and VD2 through the control device 100.

The control device 100 includes a processing circuit 110, an input-output I/F 120, and a storage unit 130.

The processing circuit 110 is implemented by, for example, a hardware processor such as a central processing unit (CPU) executing a program (software). Some or all of these constituent components may be implemented by hardware (circuit unit; including circuitry) such as a large scale integration (LSI), an application specific integrated circuit (ASIC), a field-programmable gate array (FPGA), a graphics processing unit (GPU), or a system on a chip (SOC), or may be implemented through a collaboration of software and hardware.

The input-output I/F 120 is an interface that mediates input and output of data, signals, and the like between the control device 100 and external systems. For example, a reproduction signal generated by the processing circuit 110 is output to the amplifiers Amp1 and Amp2 through the input-output I/F 120. In addition, navigation information output from a non-illustrated navigation system is input to the processing circuit 110 through the input-output I/F 120. The input-output I/F 120 outputs a display signal for displaying a graphical user interface (GUI) screen on the instrument panel IN and inputs an operation signal according to a GUI operation following a touch on the instrument panel IN.

A storage unit 130 is implemented by a storage device such as a hard disk drive, a flash memory, or a random access memory (RAM) and stores, for example, programs executed by the processing circuit 110 and various kinds of data needed when the processing circuit 110 executes the programs. The programs may be stored in the storage unit 130 in advance or may be stored in a removable storage medium such as a digital versatile disc (DVD) or a compact disc read-only memory (CD-ROM) and installed from a drive device on which the storage medium (non-transitory storage medium) is mounted onto the storage unit 130 through the input-output I/F 120.

### Exemplary Configuration of Vibration Effect System

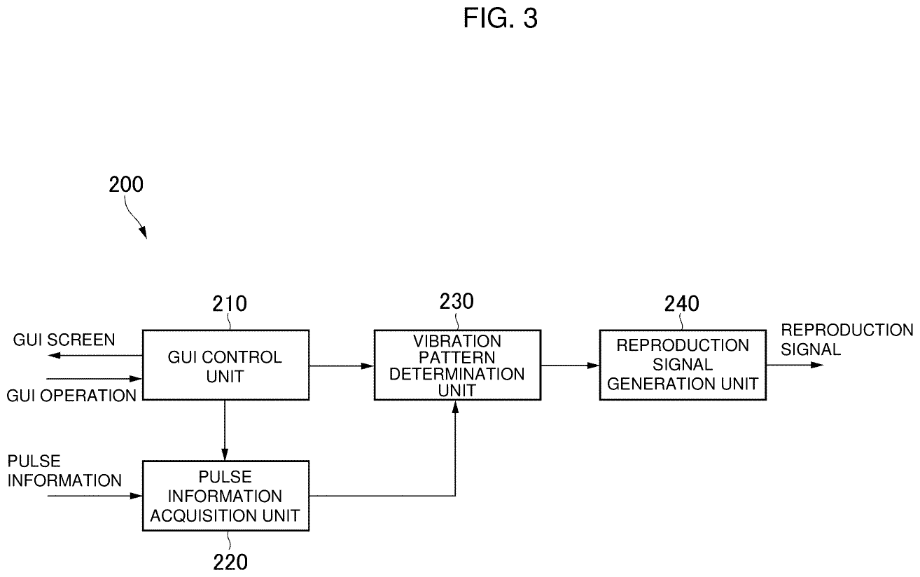

FIG. 3 is a block diagram illustrating an exemplary functional configuration of a vibration effect system 200 implemented by the control device 100 in FIG. 2 executing a vibration effect program.

As illustrated in FIG. 3, the vibration effect system 200 includes a GUI control unit 210, a pulse information acquisition unit 220, a vibration pattern determination unit 230, and a reproduction signal generation unit 240.

The vibration effect system 200 can provide a user experience of various vibration effects by executing a demonstration that showcases performance of each of various vibrations that can be generated in the steering wheel SW. For example, in the present embodiment, a first vibration effect that provides a user experience of left-right vibration feedback, a second vibration effect that provides a user experience of vibration feedback in synchronization with music, a third vibration effect that provides a user experience of vibration feedback across a wide range of frequencies, and a fourth vibration effect that provides a user experience of vibration feedback in synchronization with a heartbeat will be described below. The vibration effect system 200 can support vibration effects other than these and can add vibration effects later using Over-The-Air (OTA), for example.

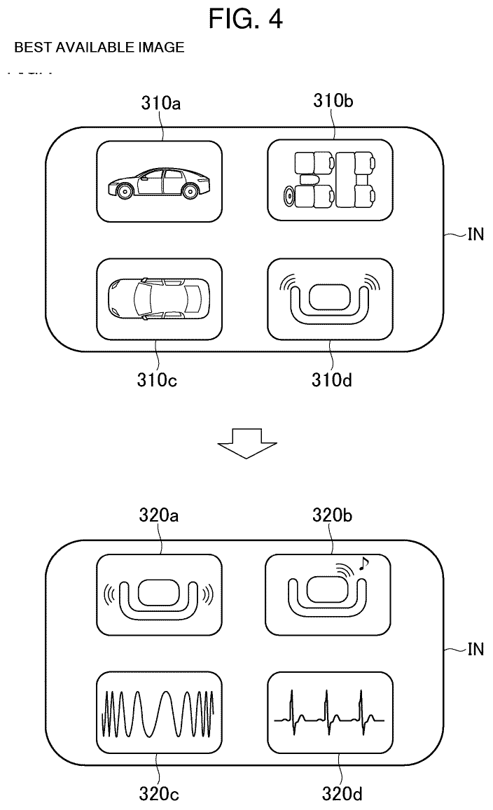

The GUI control unit 210 outputs a display signal to the instrument panel IN through the input-output I/F 120 to display a GUI screen for selecting a vibration effect that provides a user experience in a demonstration that showcases vibration performance of the steering wheel SW. As described later with reference to FIG. 4, four GUI buttons 320a to 320d for instructing execution of the first to fourth vibration effects are displayed on the GUI screen. Then, when a user performs a GUI operation to touch any of GUI buttons 320, an operation signal according to the GUI operation is input to the GUI control unit 210 through the input-output I/F 120.

Thus, the GUI control unit 210 can instruct a vibration effect to the vibration pattern determination unit 230 based on the operation signal, the vibration effect being selected by the user from among the first to fourth vibration effects. In a case where the fourth vibration effect that provides a user experience of vibration feedback in synchronization with a heartbeat is selected, the GUI control unit 210 instructs the pulse information acquisition unit 220 to acquire pulse information.

According to the instruction from the GUI control unit 210, the pulse information acquisition unit 220 acquires pulse information indicating the user's pulse detected by a non-illustrated pulse sensor, for example, through the input-output I/F 120. Then, the pulse information acquisition unit 220 supplies the pulse information to the vibration pattern determination unit 230.

The vibration pattern determination unit 230 determines vibration pattern data to be used to generate vibration with the vibration effect according to the instruction from the GUI control unit 210 and supplies the vibration pattern data to the reproduction signal generation unit 240.

For example, in a case where the first vibration effect that provides a user experience of left-right vibration feedback is selected by the user, the vibration pattern determination unit 230 acquires, from the storage unit 130, vibration pattern data representing left-right vibration feedback and produced in advance for a demonstration. In a case where the second vibration effect that provides a user experience of vibration feedback in synchronization with music is selected by the user, the vibration pattern determination unit 230 produces vibration pattern data representing vibration feedback according to a piece of music for a demonstration or a piece of music designated by the user. In a case where the third vibration effect that provides a user experience of vibration feedback across a wide range of frequencies is selected by the user, the vibration pattern determination unit 230 acquires, from the storage unit 130, vibration pattern data representing vibration feedback across a wide range of frequencies and produced in advance for a demonstration. In a case where the fourth vibration effect that provides a user experience of vibration feedback in synchronization with a heartbeat is selected by the user, the vibration pattern determination unit 230 produces vibration pattern data according to the pulse information supplied from the pulse information acquisition unit 220.

The reproduction signal generation unit 240 generates a reproduction signal for generating vibration in the steering wheel SW according to the vibration pattern data supplied from the vibration pattern determination unit 230. Then, the reproduction signal generation unit 240 outputs the reproduction signal to the amplifiers Amp1 and Amp2 through the input-output I/F 120.

Accordingly, the vibration device VD1 vibrates according to the reproduction signal amplified by the amplifier Amp1 and the vibration device VD2 vibrates according to the reproduction signal amplified by the amplifier Amp2, thereby generating desired vibration in the steering wheel SW.

The vibration effect system 200 configured as described above can perform a demonstration that showcases vibration performance of the steering wheel SW by using a GUI screen displayed on the instrument panel IN and provide a user experience of a vibration effect selected by the user. The vibration effect system 200 can provide a user experience of left-right vibration feedback (for example, vibration that moves in the right-left direction), provide a user experience of vibration feedback in synchronization with music (for example, fine vibration synchronized with the rhythm and melody of music), provide a user experience of vibration feedback across a wide range of frequencies (for example, vibration that varies from high frequencies to low frequencies), and provide a user experience of vibration feedback in synchronization with a heartbeat (for example, vibration that changes the heartbeat cycle in real-time in coordination with the pulse sensor).

Thus, the vibration effect system 200 can showcase vibration performance of the steering wheel SW to a customer (user) at an exhibition of the vehicle M, for example, and provide a user experience of improved vibration effects.

An example of a GUI screen displayed on the instrument panel IN will be described below with reference to FIG. 4.

For example, when the vehicle M is in a demonstration mode, a GUI screen on which a plurality of GUI buttons 310 for instructing execution of various demonstrations are disposed is displayed on the instrument panel IN as illustrated in the upper part of FIG. 4. In the display example illustrated in FIG. 4, the four GUI buttons 310a to 310d are displayed. For example, a GUI screen as illustrated in the lower part of FIG. 4 is displayed on the instrument panel IN when a GUI operation to touch the GUI button 310d is performed by the user in a case where the GUI button 310d instructs execution of a demonstration that showcases vibration of the steering wheel SW.

The plurality of GUI buttons 320 for instructing execution of various vibration effects are disposed on the GUI screen illustrated in the lower part of FIG. 4. In the display example illustrated in FIG. 4, the GUI button 320a for instructing execution of the first vibration effect that provides a user experience of left-right vibration feedback, the GUI button 320b for instructing execution of the second vibration effect that provides a user experience of vibration feedback in synchronization with music, the GUI button 320c for instructing execution of the third vibration effect that provides a user experience of vibration feedback across a wide range of frequencies, and the GUI button 320d for instructing execution of the fourth vibration effect that provides a user experience of vibration feedback in synchronization with a heartbeat are displayed. Then, when a GUI operation to touch any of the GUI buttons 320 is performed by the user, the vibration effect corresponding to the GUI button 320 is executed.

In this manner, the vibration effect system 200 can provide a user experience of an improved vibration effect with the steering wheel SW through selection of a desired vibration effect by the user using a GUI screen displayed on the instrument panel IN.

Although vibration effect processing using a GUI screen displayed on the instrument panel IN of the vehicle M will be described in the present embodiment, the GUI screen may be displayed on a smartphone of the user, for example, to perform the vibration effect processing in the same manner.

### Exemplary Processing of Vibration Effect Processing

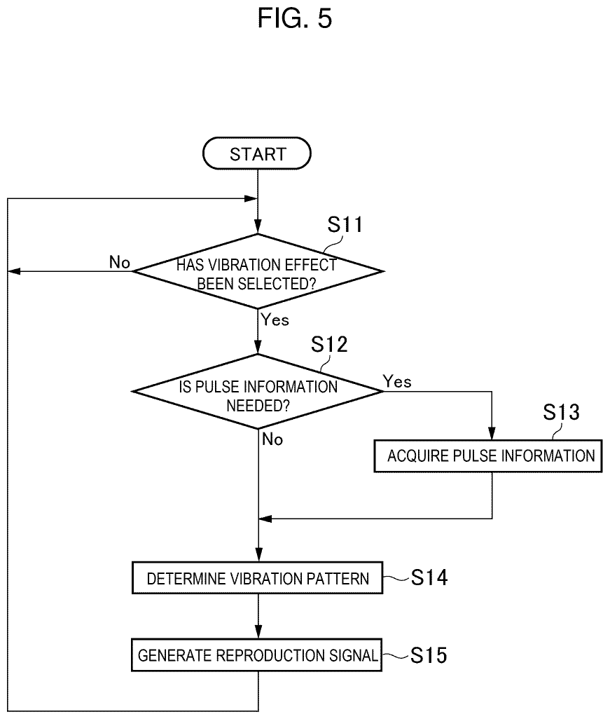

The vibration effect processing executed by the vibration effect system 200 will be described with reference to a flowchart illustrated in FIG. 5.

The processing is started, for example, when the vehicle M is set to the demonstration mode and execution of a demonstration that showcases vibration performance of the steering wheel SW is instructed. At step S11, the GUI control unit 210 displays, on the instrument panel IN, a GUI screen on which the plurality of GUI buttons 320 are disposed as illustrated in the lower part of FIG. 4, for example, and determines whether any of vibration effects has been selected. The GUI control unit 210 can determine that any of vibration effects has been selected, for example, when having acquired an operation signal indicating that the user has performed a GUI operation to touch any of the plurality of GUI buttons 320.

At step S11, in a case where the GUI control unit 210 determines that no vibration effect has been selected, the processing is put on standby. Then, in a case where the GUI control unit 210 determines that any of vibration effects has been selected, the processing proceeds to step S12.

At step S12, the GUI control unit 210 determines whether pulse information is needed according to selection of a vibration effect by the user. The GUI control unit 210 determines that pulse information is needed, for example, in a case where the user selects the fourth vibration effect that provides a user experience of vibration feedback in synchronization with a heartbeat.

At step S12, in a case where the GUI control unit 210 determines that pulse information is needed, the processing proceeds to step S13 and the GUI control unit 210 instructs the pulse information acquisition unit 220 to acquire the pulse information. Then, when the pulse information acquisition unit 220 acquires the pulse information indicating the user's pulse detected by a non-illustrated pulse sensor and supplies the pulse information to the vibration pattern determination unit 230, the processing proceeds to step S14.

At step S12, in a case where the GUI control unit 210 determines that the pulse information is not needed, the processing skips step S13 and proceeds to step S14.

At step S14, the GUI control unit 210 instructs the vibration effect selected by the user to the vibration pattern determination unit 230, and the vibration pattern determination unit 230 determines vibration pattern data to be used to generate vibration with the vibration effect according to the instruction. In a case where the fourth vibration effect that provides a user experience of vibration feedback in synchronization with a heartbeat is selected by the user, the vibration pattern determination unit 230 produces vibration pattern data according to the pulse information supplied from the pulse information acquisition unit 220 at step S13. Then, the vibration pattern determination unit 230 supplies, to the reproduction signal generation unit 240, the vibration pattern data that has been determined to be used to generate vibration with the vibration effect and has been acquired or produced.

At step S15, the reproduction signal generation unit 240 generates a reproduction signal for generating vibration in the steering wheel SW according to the vibration pattern data supplied from the vibration pattern determination unit 230 at step S14. Then, the reproduction signal generation unit 240 outputs the reproduction signal to the amplifiers Amp1 and Amp2 through the input-output I/F 120, and then the processing returns to step S11 to repeatedly perform the same processing.

Thereafter, the vibration effect processing is ended when the user has performed an operation to instruct termination of the demonstration or when a certain time has elapsed since start of the demonstration.

Through execution of the vibration effect processing as described above by the vibration effect system 200, it is possible to perform a demonstration that can sufficiently showcase vibration performance of the steering wheel SW, thereby providing a user experience of improved vibration effects.

The above-described series of processing (vibration effect program) may be executed by hardware or software. In a case where the series of processing is executed by software, programs included in the software are installed on a computer. Examples of the computer include a computer that is incorporated in dedicated hardware and a general-purpose personal computer that is capable of executing various functions with various programs installed thereon.

The programs executed by the computer may be programs that are processed in a temporally sequential manner along an order described in the present specification, or may be programs that are processed in parallel or at necessary timings, for example, when called.

The processing performed by the computer according to the programs does not necessarily need to be performed in a temporally sequential manner along an order written in the flowcharts. Specifically, the processing performed by the computer according to the program includes processing executed in parallel or individually (for example, parallel processing or processing by objects).

The programs may be processed by one computer (processor) or in a distributed manner by a plurality of computers. Moreover, the programs may be forwarded to and executed by a remote computer.

In the present specification, a system means a set of a plurality of constituent components (such as devices and modules (components)) irrespective of whether all constituent components are located in the same housing. Thus, a plurality of devices housed in separate housings and connected through a network, and one device with a plurality of modules housed in one housing are each a system.

For example, a component described above as one device (or processing unit) may be divided and configured as a plurality of devices (or processing units). In contrast, components described above as a plurality of devices (or processing units) may be collectively configured as one device (or processing unit). Components other than those described above may be added to the configuration of each device (or processing unit). Moreover, part of the configuration of a device (or processing unit) may be included in the configuration of another device (or processing unit) as long as the configuration and operation of the entire system remain the same in effect.

The present technology may adopt, for example, a cloud computing configuration in which one function is distributed and collaboratively processed by a plurality of devices through a network.

For example, the above-described programs may be executed at an optional device. In this case, the device may be configured to be able to have necessary functions (such as functional blocks) and obtain necessary information.

For example, each step in the above-described flowcharts may be executed at one device or at a plurality of devices in a distributed manner. In a case where a plurality of processes are included in one step, the plurality of processes included in the one step may be executed at one device or at a plurality of devices in a distributed manner. In other words, a plurality of processes included in one step may be executed as processing at a plurality of steps. In contrast, processing described above as a plurality of steps may be collectively executed as one step.

Note that processes at steps that describe a program executed by the computer may executed in a temporally sequential manner along an order described in the present specification or may be executed in parallel or individually at necessary timings, for example, when called. In other words, the processes at steps may be executed in an order different from the above-described order as long as no inconsistency occurs. Moreover, processes at steps that describe the program may be executed in parallel or combination with processes of another program.

Note that the plurality of present technologies described above in the present specification may be each independently implemented as long as no inconsistency occurs. Moreover, a plurality of optional present technologies in the present specification may be implemented in combination. For example, some or all present technologies described above in either embodiment may be implemented in combination with some or all present technologies described above in another embodiment. Furthermore, some or all optional present technologies described above may be implemented in combination with other technologies that are not described above.

Note that the present embodiment is not limited to the above-described embodiment but may be changed in various kinds of manners without departing from the scope of the present disclosure. Effects described in the present specification are merely exemplary and not limiting, and may include other effects.

### REFERENCE SIGNS LIST

10 operation support ECU; 20 steering device; 30 steering sensor group; 40 vehicle sensor group; 100 control device; 110 processing circuit; 120 input-output I/F; 130 storage unit; 200 vibration effect system; 210 GUI control unit; 220 pulse information acquisition unit; 230 vibration pattern determination unit; 240 reproduction signal generation unit

1. An in-vehicle system comprising:
a GUI control unit configured to
control a displaying of, on a graphical user interface (GUI) screen, a plurality of GUI buttons each corresponding to a respective one of a plurality of vibration effects to be generated in a steering wheel of a vehicle, and
receive, via a corresponding GUI button of the plurality of GUI buttons displayed on the GUI screen, a user selection of a vibration effect from among the plurality of vibration effects;
a vibration pattern determination unit configured to determine vibration pattern data to be used to generate vibration with the vibration effect of the received user selection; and
a signal generation unit configured to generate a signal for generating vibration according to the vibration pattern data supplied from the vibration pattern determination unit,
wherein the GUI control unit, the vibration pattern determination unit, and the signal generation unit are each implemented via at least one processor.

2. (canceled)

3. The in-vehicle system according to claim 1, wherein a first vibration effect that provides a user experience of left-right vibration feedback, a second vibration effect that provides a user experience of vibration feedback in synchronization with music, a third vibration effect that provides a user experience of vibration feedback across a wide range of frequencies, and a fourth vibration effect that provides a user experience of vibration feedback in synchronization with a heartbeat are used as the vibration effects.

4. The in-vehicle system according to claim 3, wherein in a case where the first vibration effect is selected, the vibration pattern determination unit acquires the vibration pattern data representing left-right vibration feedback and produced in advance for a demonstration from a storage unit.

5. The in-vehicle system according to claim 3, wherein in a case where the second vibration effect is selected, the vibration pattern determination unit produces the vibration pattern data representing vibration feedback according to a piece of music for a demonstration or a piece of music designated by a user.

6. The in-vehicle system according to claim 3, wherein in a case where the third vibration effect is selected, the vibration pattern determination unit acquires the vibration pattern data representing vibration feedback across a wide range of frequencies and produced in advance for a demonstration from a storage unit.

7. The in-vehicle system according to claim 3, further comprising a pulse information acquisition unit configured to acquire pulse information indicating a user's pulse detected by a pulse sensor, wherein
in a case where the fourth vibration effect is selected, the pulse information acquisition unit acquires the pulse information and supplies the pulse information to the vibration pattern determination unit, and
the vibration pattern determination unit produces the vibration pattern data according to the pulse information.

8. A non-transitory computer-readable medium having embodied thereon a program, which when executed by a computer causes the computer to execute a processing method, the method comprising:
displaying, on a graphical user interface (GUI) screen, a plurality of GUI buttons each corresponding to a respective one of a plurality of vibration effects to be generated in a steering wheel of a vehicle, and
receiving, via a corresponding GUI button of the plurality of GUI buttons displayed on the GUI screen, a user selection of a vibration effect from among the plurality of vibration effects;
determining vibration pattern data to be used to generate vibration with the vibration effect of the received user selection; and
generating a signal for generating vibration according to the vibration pattern data.

9. A processing method comprising:
displaying, on a graphical user interface (GUI) screen, a plurality of GUI buttons each corresponding to a respective one of a plurality of vibration effects to be generated in a steering wheel of a vehicle, and
receiving, via a corresponding GUI button of the plurality of GUI buttons displayed on the GUI screen, a user selection of a vibration effect from among the plurality of vibration effects;
determining vibration pattern data to be used to generate vibration with the vibration effect of the received user selection; and
generating a signal for generating vibration according to the vibration pattern data.
